(19) United States
(12) Patent Application Publication
(10) Pub. No.: US 2004/0111385 A1
(43) Pub. Date: Jun. 10, 2004

(54) Controlled selection of inputs

(76) Inventor: Andrew Joe Starkey, Aberdeen (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/466,401

(22) PCT Filed: Jan. 15, 2002
(86) PCT No.: PCT/GB02/00160

(30) Foreign Application Priority Data
Jan. 15, 2001 (GB) 0101043.8

(51) Int. Cl. G06F 17/00; G06N 5/02; G06F 15/18

(52) U.S. Cl. 706/46; 706/12

(57) ABSTRACT

The invention relates to a selection process for input parameters intended for application to an intelligent processing system such as a neural network, or in the implementation of an intensive data handling operation, such as data mining. The selection process involves producing an indication of the state of organisation of the parameters and selecting them for use in the processing system or data handling operation if their state of organisation is indicated to be sufficient. If the state of organisation of the parameters is not deemed sufficient, their various influences are automatically determined and at least one parameter tending to disturb the state of organisation is rejected. A revised indication of the state of organisation of the remaining parameters is then produced, and the selection process is repeated until either a satisfactory indication is produced, at which point the relevant parameters are applied to the processing system or data handling operation, or insufficient parameters remain to produce a reliable indication.

This invention relates to a selection process for input parameters. The process may be used, for example, to select input parameters for application to an intelligent processing system i.e. a self-organising and trainable system such as a neural network, or in the implementation of an intensive data handling operation, such as data mining.

Neural networks, trained to respond to certain input data describing parameters representative of, or otherwise relevant to, a given procedure are powerful tools that are being used increasingly to supervise the performance of, or even to implement, such procedures. In this respect, neural networks are commonly used to implement or supervise procedures such as technical processes and the analysis of operational data collected from monitored installations.

In one particular example of such a procedure, neural networks are used to analyse data collected, from time to time, from installations effecting ground anchorage in mining and similar environments. The neural network is configured to operate upon the collected data in order to provide an indication as to the continued integrity of the anchorage.

Despite the undoubted power and adaptability of neural networks and other intelligent processing systems, difficulties arise in ensuring that they are provided with the appropriate input parameters; one reason for this being that they tend to operate as closed systems, providing virtually no feedback to the user as to the value or relevance of individual input parameters to the overall operation.

This in exacerbated by the fact that the power of such systems is such that there is often no need for the user to actually understand the operation being monitored or processed, and thus often it is not possible for a human operative to exert logical, or even intuitive, judgement over the selection of input parameters. Even if such judgements can be made, the procedure by means of which the selection of input parameters is influenced by human interaction can be protracted, rendering it unsuitable for use, for example, in on-line processes, and moreover, such interaction is error-prone.

This invention seeks to address the above-mentioned difficulties.

According to the invention there is provided a process for selecting input parameters for an intelligent processing system or a data manipulating operation, the process including the steps of:

(a) applying said input parameters to a pre-processor capable of providing an indication or a state of organisation of said parameters as a whole;

(b) selecting said parameters it the state of said organisation of said parameters as a whole is a determined to be sufficient; otherwise:

(c) analysing said indication to determine the influence of at least some of sold input parameters thereupon;

(d) rejecting one or more of said parameters based upon the degree of said influence; and

(e) repeating steps (a), (b), (c) and (d) until the said state of organisation of said parameters as a whole is determined to be sufficient.

The invention thus provides automatic and iterative preprocessing of input parameters in order to ensure that those applied to the intelligent processing system, or used in the data manipulating operation, make a positive contribution to the processing.

Preferably, the intelligent processing system comprises a neural network. Such networks are selected for general applicability to the nature of the information to be processed thereby, and are self-trained in operation, by repeated exposure to the relevant input parameters, to render them usefully responsive to the specifics of the system or process to which the parameters relate.

Preferably also, the aforesaid steps of analysing said indication to determine the influence of at least some of said input parameters thereupon, and rejecting one or more of said parameters based upon the degree of said influence takes account both of positive and negative influences of said parameters on the said state of organisation of said parameters as a whole. This permits rejection of parameters that have a tendency to disorganise other information as well as those which are of no direct assistance in organizing such information.

Preferably, input parameters are selected in dependence upon their tendency to relate to common recognisable information conditions and/or their tendency not to suppress other relevant information.

Further preferably, the process is such that the input parameters are derived from data samples (the processing of a single data sample typically yielding a plurality of input parameters) and the pre-processor is adapted to select data samples in correlated groups; each group conforming to a respective condition distinct from that of other groups.

The selected input parameters may, as mentioned previously, be applied to an intelligent processing system. Alternatively, they may be used to directly implement intensive data manipulative operations, such as data mining.

In either event, and in accordance with preferred embodiments of the invention, the pre-processor is constituted by a self-organising map (SOM) processor; such processors being themselves neural networks. These devices are capable of providing an indication of a state of organisation of input parameters applied to them, and thus of the influence that such parameters will have upon the performance of the system or operation to which they are applied.

The SOM is preferably used iteratively to, effect retention or rejection, as appropriate, of various input parameters.

In order that the invention may be clearly understood and readily carried into effect, one embodiment thereof will now be described, by way of example only, with reference to the accompanying drawings, of which:

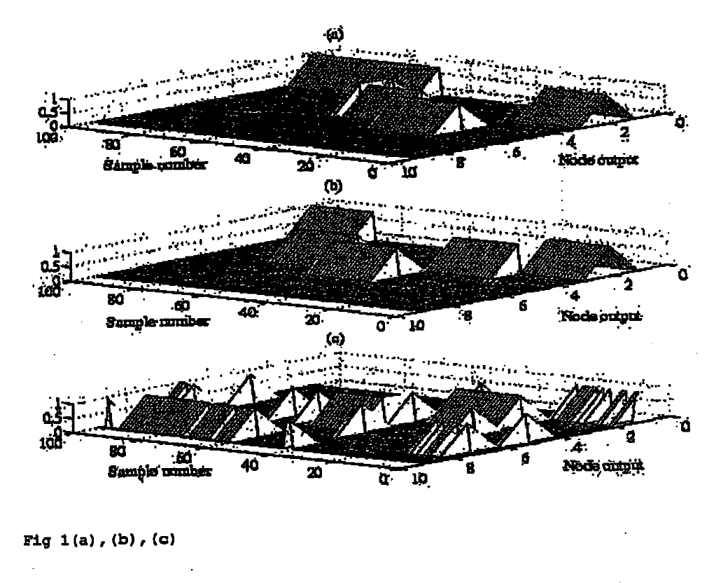

FIGS. 1(a), 1(b) and 1(c) show, in perspective view, an indication of a state of organisation of certain input parameters intended to be applied to a neural network for processing;

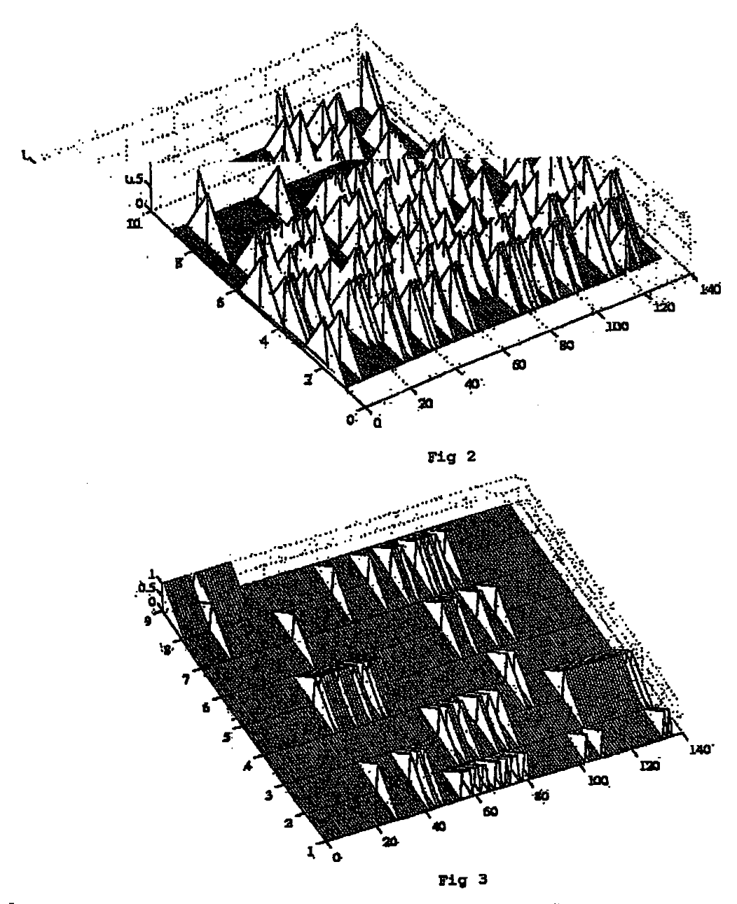

FIG. 2 shows, in similar view to FIG. 1, an indication of the output of a pre-processor organised to apply input parameters to a neural network;

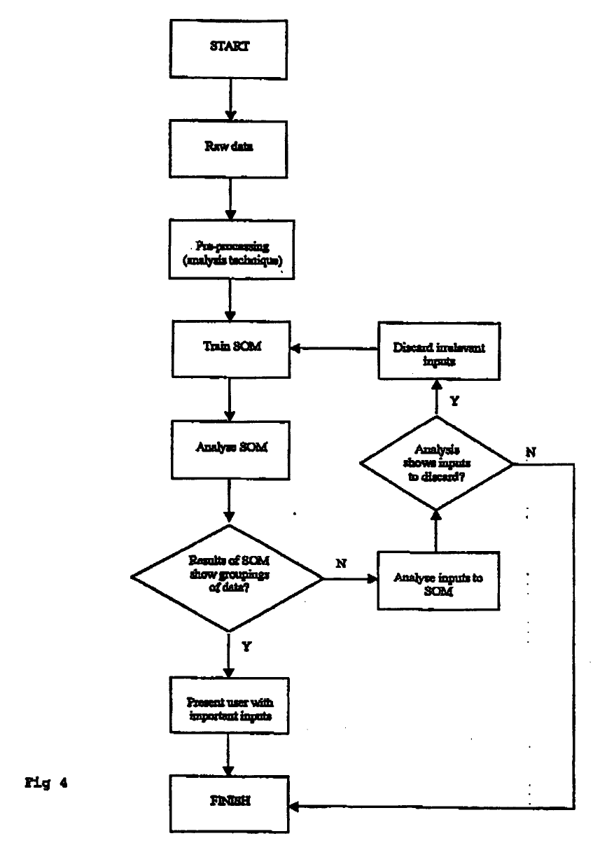

FIG. 3 shows, in similar view to FIG. 2, an indication of the output of said pre-processor following refinement of the input parameter selection by means of a process in accordance with an example of the invention; and

FIG. 4 shows a flow diagram indicative of the operation of a process in accordance with one example of the invention.

This embodiment of the invention relates to the application of neural network processing to data collected from ground anchorage monitoring installations, but it is stressed at the particular application is irrelevant to the operation of the invention, which is thus widely applicable.

In assessing the continued integrity of ground anchorages, one procedure that is now commonly applied is to apply calibrated shock forces thereto, and to utilise a sensor package, coupled to the anchorage, to collect measurement data indicative of the response of the anchorage to such forces. In on known arrangement, the measurement data collected by the sensor package relates to the frequency response of the anchorage to the calibrated shook force, but other forms of measurement data can of course be collected, alternatively or in addition to frequency response data, if preferred. In any event, the input parameters relating to frequency and/or other data are supplemented with other input parameters relating to the specific anchorage installation under test. Such data may be applied manually and/or automatically to the neural network, and may relate to such factors as age, mounting type, anti-vibration fittings and environmental factors such as the type of medium into which the anchorage has been driven and weather and climatic data.

In any event the measurement data, duly collected by the sensor package, are applied as input parameters to a neural network processor that is capable of responding to the inputs by providing an output indicative of the integrity of the anchorage. An mentioned previously, a characteristic of neural networks in that they can be trained, by the repeated application of suitable calibrator inputs, to respond intelligently to the application of unknown, or at least uncalibrated, inputs.

Referring now to FIGS. 1(a) to 1(c), there is shown an indication of the performance of an SOM to three different sets of input parameters.

On this example, the three sets of parameters relate respectively to data collected from anchorages by way of response to impacts applied thereto via cushioning using three different thicknesses of rubber; shown on the drawings as thin, 2 mm and 3 mm respectively.

As can be seen from FIG. 1(a), the response of the SOM to the data derived in response to impacts cushioned by thin rubber has been to identify four condition within the data, and that it has labelled samples 1 to 20 as node 2; samples 21 to 40 as node 5; samples 41 to 60 as node 4 and samples 61 to 100 an node 1. This response is indicative of a good state of organisation of the data as a whole, but the fact that unequal numbers of samples have been allocated (cf. an allocation of forty samples to node 1 as opposed to the allocation of twenty samples each to nodes 2, 5 and 4) indicates that the input data may not be optimally organised. The results, shown in FIG. 1(c), for 3 mm thick rubber cushioning, on the other hand, are fairly chaotic, with the SOM allocating a wide distribution of nodes across the spectrum of samples.

The results for 2 mm thick rubber show good organisation and optimal group selection, with the SOM identifying five different conditions across the sample data; each condition containing twenty samples. There is thus good definition between conditions and good correlation between the respective samples conforming to each condition. The SOM trained on data derived from impact via 2 mm rubber cushioning is correct in its diagnosis, and it can thus be taken that the data collected from impacts using 2 mm cushioning are better for the anchorage from which these results were taken, and should be applied to the neural network along with the other inputs to which reference has previously been made.

Inspection of the organisation of the results of having the SOMs operate upon different sets of input parameters can thus reveal which configuration of the system is best, and thus should be used in the relevant procedure. It can thus be seen that an SOM is capable of determining, by itself and in an unsupervised manner, which set of input parameters contains five separate conditions, each containing a similar number of well correlated samples. It can do this as the input parameters relating to the 2 mm rubber configuration are dissimilar enough from each other to allow their separate recognition and classification into well-defined conditions; whilst the data within each condition a sufficiently similar to one another that they correlate together sufficiently well that the SOM does not attempt to classify them elsewhere. The data for the other two configurations (thin rubber and 3 mm thick rubber) do not separate the conditions as efficiently, nor (in the case of 3 mm rubber) are they sufficiently similar, within a condition, for the SOM to recognise such a relationship.

The same approach can thus be used to identify whether or not the inputs to the SOM are the optimum parameters. In general, and starting with all possible inputs to the SOM, the procedure is as follows:—

1. Train the SOM;

2. For each condition c:

If more than p% of the samples for condition c fire the same node of the SOM then:

Label the condition c as “diagnosed”;

determine which inputs have the moat influence on the firing of the node and on the suppression of the firing of other nodes;

store the Nd inputs that have the most influence, an determined in the previous step, and store in a variable (DIAGc);

Otherwise, the samples for condition c fire a number of nodes and so:

label the condition as “misdiagnosed”;

determine which input have the most influence on the firing of the nodes and on the suppression of the firing of other nodes;

store the Nm inputs which have the most influence as determined in the previous step and store in the firing of the nodes for this condition in another variable (MISDIAGc);

3. identify which inputs are present in the MISDIAGc variable that are not present in the DIAGc variable;

4. remove those inputs identified in step 3, thereby reducing the size of the input data set; and

5. repeat from step 1 with the reduced input data set until all conditions are classified as diagnosed, or until insufficient inputs remain.

In order to determine which inputs are the most important in the firing of a node, the method favoured at present is an examination of the quantization error, a process explained by Andreas Rauber in a paper entitled “LabelSOM: On the Labelling of Self-Organising Maps”, but other methods can be used if preferred.

It will be recognised that possible conflicts can occur at Step 3, where the same inputs could be identified as important in the misdiagnosis of one condition and also for the diagnosis of another condition. It may be preferred to introduce a further rule at this stage, permitting more importance to be given to particular input parameters under certain conditions in the diagnostic process.

The possibility in also envisaged of storing the results of previous input data sets and arranging that, if the current performance of the SOM is worse than that at a previous step, the algorithm reverts back to the input data act of the previous steps, and removes different input parameters.

The approach outlined below, comprising an embodiment of the invention, led to the production of the results illustrated in FIGS. 2 and 3, from which it can be seen that the algorithm has approached a solution for the optimum input to the SOM for the given conditions and input data. In this example, the number of inputs at the start of the processing was 269, and the results shown in FIG. 3 are at the point at which the SOM has reduced the number of inputs to 119. As can be seen in FIG. 3, the automated SOM regime has begun to identify which parameters promote the recognition of each condition. In each Figure, each condition is shown every 25 samples, against the output of the SOM (a 3×3 architecture) which is from node 1 to node 9.

The inputs to the SOM in this example are from the processing of the raw data films by wavelet analysis, a form of signal processing that allows inspection of the data in both the time and frequency domains. The reduction, of the inputs from 269 to 119 that is accomplished by means of this embodiment of the invention has allowed the significant areas in the response signature, in terms of frequency and time, to be identified in an automated fashion. In this case, the analysis discarded high frequencies and retained data that immediately followed the impulse from the impact device.

It will be observed that the technique employs unsupervised neural networks and the iterative use of previous knowledge in order to retain or reject and discard input parameters.

In one detailed implementation of the invention, the following operations were carried out:

perform preliminary analysis by discarding input parameters whose mean*std over the input data set is <0.000001.

until either the number of inputs falls below 10, or all conditions are diagnosed, the following steps are taken to reduce the input parameter set to these input parameters which are important.

train SOM; the required SOM capacity be at least twice the number of inputs. The default training time is arbitrarily not at 3000 events.

cycle through each sample and calculate the quantization error and firing node value for each weight in the SOM.

cycle through each sample a second time, in order to calculate which node is fired for each sample. Multiply the values of the input parameters with the SOM weight values for this winning mode, and store in a variable called “fire”. In a similar manner, the input parameters which create large negative values (in nodes which are not fired) are calculated.

repeat the following until parameters are found to discard

go through each condition in turn, one at a time

for the current condition, identify which SOM node has been fired the most

if this node has been fired above a given percentage, then that condition is classified as successfully diagnosed by the SOM. If the node has been fired below a given percentage, then that condition is classified as not successfully diagnosed by the SOM

if the condition has been labelled as diagnosed, then:

loop through each of the samples given in the variable “fire” calculated earlier; this is normally equivalent only to a single condition at a time.

for each sample, sort the firing values in order of size, and calculate the cumulative sum. This identifies the position, within the data set, at which the given percentage of the total firing value is reached. All parameters up to this position are then returned in the variable “maxpos”.

the negative input parameters which were determined earlier are also added to this variable. These negative input parameters are for parameters which contribute a large negative value to nodes which are not fired.

if the condition has been labelled as misdiagnosed, then:

if the maximum percentage of samples recognized for this condition by any one node is greater than or equal to 45%, then it is assumed that this node is basically sound, and that its input parameters should not all be marked as bad (for misdiagnosis). Therefore it is chosen only to mark input parameters as bad if they contribute to the firing of nodes other than the one which managed 45%. The next step is thus to calculate the, sample numbers, within the current condition, which fire nodes other than the one which managed 45%. If two nodes manage 45%, the first is taken as being successful, and the second is treated as bad.

if the maximum percentage of samples recognised for this condition by any one node is less than 45%, then the entire condition is classified as misdiagnosed, and so all the sample numbers for this condition will be used.

for the sample numbers calculated in the above two steps, calculate the input parameters which are important for firing the nodes which are leading to the misdiagnosis of the condition. The indexes for these input parameters are stored in a variable which accumulates over all misdiagnosed conditions.

add in the indexes for the input parameters which create large negative values for “netweights*inputdata” for the same sample numbers, as these large negative values may be suppressing the firing of a node that could diagnose this condition.

evaluate which input parameters are contributing to the misdiagnosis of samples only.

evaluate which input parameters are contributing to both the diagnosis and the misdiagnosis of samples.

ascertain how many input parameters should be discarded; the discard ratio is presently set, arbitrarily, at 10% of the total number of input parameters.

identify any input parameter which is only contributing towards misdiagnosed conditions, and has not already been assigned to the set of input parameters to discard in the next cycle. Any such input parameter is added to the set of input parameters to discard, and the number of input parameters to discard is consequently reduced by one.

if no input parameters have been added to the set of input parameters to discard, and the percentage of important input parameters returned for misdiagnosis has reached 98%, then the previous step in repeated for the input parameters which contribute to both misdiagnosis and diagnosis.

if no input parameters have been discarded in this cycle, then the percentage of important input parameters returned is incremented by command “returnimportantindexes”. If the percentage in below 95%, then the increment is 5% (beginning at 70%). If the percentage is above 95%, then the increment is 1%.

save the analysis at each step into a history variable which is, in turn, saved to disk before the next cycle is started.

FIG. 4 shows, in flow diagrammatic form, the operational stages in the embodiment of the invention used in connection with the above-described example.

1. A process for selecting input parameters for application to an intelligent processing system or a data manipulating operation, the process including the steps of:—
(a) applying said input parameters to a pre-processor capable of providing an indication of a state of organisation of said parameters as a whole,
(b) selecting said parameters if the state of said organisation of said parameters as a whole is determined to be sufficient; otherwise:
(c) analysing said indication to determine the influence of at least some of said input parameters thereupon,
(d) rejecting one or more of said parameters based upon the degree of said influence, and
(e) repeating steps (a), (b), (c) and (d) until the said state of organisation of said parameters as a whole is determined to be sufficient.

2. A process according to claim 1 intended to subject input parameters to automatic and iterative pre-processing in order to ensure that those parameters selected make a positive contribution to said system or operation.

3. A process according to claim 1 or claim 2 wherein the intelligent processing system comprises a neural network.

4. A process according to claim 3 wherein said neural network is selected for general applicability to the nature of the information to be processed thereby, and self-trained in operation, by repeated exposure to the relevant input parameters, to render it usefully responsive to the specifics of a system or process to which the parameters relate.

5. A process according to any preceding claim wherein the said steps of analysing said indication to determine the influence of at least some of said input parameters thereupon, and rejecting ne or more of said parameters based upon the degree of said influence take account both of positive and negative influences of said parameters on the said state of organisation of said parameters as a whole, thereby to permit rejection of parameters that have a tendency to disorganise other information as well as those which are of no direct assistance in organising such information.

6. A process according to any preceding claim wherein input parameters are selected in dependence upon their tendency to relate to common recognisable information conditions and/or their tendency not to suppress other relevant information.

7. A process according to any preceding claim further comprising the steps of storing the results of previous input data sets and, if a current performance of the pre-processor is worse than that at a previous step, causing the process to revert to the input data set of said previous step.

8. A process according to any preceding claim wherein the input parameters are derived from data samples and the pre-processor is adapted to select data samples in correlated groups; each group conforming to a respective condition distinct from that of other groups.

9. A process according to any preceding claim, wherein the pre-processor is constituted by a self-organising map (SOM) processor capable of providing an indication of a state of organisation of input parameters applied thereto, and thus of the influence that such parameters will have upon the performance of the intelligent processing system or the manipulating operation to which they are applied.

10. A process according to claim 9 wherein the SOM is used iteratively to effect retention or rejection, as appropriate, of various input parameters.

11. A process for selecting input parameters for application to an intelligent processing system or a data manipulating operation; the process being in substantial conformance with any generic or detailed configuration thereof herein described.
